(19) United States
(12) Patent Application Publication
(10) Pub. No.: US 2011/0285130 A1
(43) Pub. Date: Nov. 24, 2011

(54) Power System Frequency Inertia for Wind Turbines

(76) Inventor: Jan Thisted, Tjele (DK)

(21) Appl. No.: 13/145,146

(22) PCT Filed: Mar. 10, 2009
(86) PCT No.: PCT/EP2009/052745

§ 371 Date: Jul. 19, 2011

(30) Foreign Application Priority Data
Jan. 30, 2009 (EP) 09001336.8

(51) Int. Cl. H02P 9/04

(52) U.S. Cl. 290/44

(57) ABSTRACT

A wind turbine system and method are provided. The wind turbine system includes a wind turbine operable to supply wind power to an utility system; a synchronous generator coupled to the utility system; a grid measurement device arranged for measuring the current and power that is exchanged between the synchronous generator and the utility system; a controller for adjusting the output power of the wind turbine as a function of the power and current that is measured by the grid measurement device; and a means of communication between the grid measurement device, controller and/or the wind turbine, wherein the wind turbine is configured to provide current and power to the utility system as a function of the measured power and current of the grid measurement device.

### BACKGROUND OF THE INVENTION

The invention relates generally to the field of wind turbine generators used for power generation for utility grids, and more particularly to techniques for ensuring grid compliance of wind turbine generators, including stabilizing power during transient conditions.

A wind turbine generator generally includes a wind rotor that converts wind energy into rotational motion of a turbine shaft, which in turn drives the rotor of an electrical generator to produce electrical power.

Modern wind turbine generator installations typically take the form of a wind farm having multiple wind turbine generators connected to a common wind farm power grid. This wind farm grid is connected to a utility grid, either directly or through a substation which may include a step-up transformer.

Individual wind turbines and wind farms are required to comply with the power quality requirements of the utility system operator. Such power quality requirements, often designated as “grid requirements” may typically include voltage regulation, frequency regulation, active and reactive power control, fault ride-through, and in some cases also power ramping and the provision of spinning reserve or inertia in case of transient conditions caused by sudden failure of generation, line fault or connection of rapid application of large loads.

From a utility point of view it would be preferable if wind turbine generators could be fitted with classical synchronous generators having the same regulation capabilities as the synchronous generators applied at large hydro or thermal power plants. Such classical synchronous generators are capable of regulating voltage, active and reactive power etc. In transient conditions, the synchronous generators may also provide additional control services that modulate active power to stabilize the power system and restore frequency to its nominal value.

However, classical synchronous generators are not well suited for use on wind turbines, since their very stiff characteristics are not compatible with wind turbine application. In order to approximate synchronous generator operation and capabilities modern wind turbine generators typically use power electronic inverters to interface the wind turbine generator output with the utility grid. In one common approach the wind turbine generator output is directly fed to a power electronic converter, where the turbine frequency is rectified and inverted into a fixed frequency as needed by the utility system. An alternative approach uses a doubly fed asynchronous generator (DFAG) with a variable frequency power electronic inverter exciting the DFAG rotor and stator windings being coupled directly to the utility system.

Traditionally, wind turbine generators have been configured to respond to the grid requirements through the use of a combination of grid measurement devices, utility signals, and response references and algorithms internal to the turbine controller.

This arrangement has a number of drawbacks. Firstly, the wind turbine generator response to grid requirements generally becomes a black box seen from the perspective of the system operator. Secondly, feed-back response elements may occur where the wind turbine generator system regulates in response to self-created artifacts. Furthermore, in the normal configuration wind turbines do not contribute to the frequency stabilization of the utility system.

The purpose of the invention is to overcome the above mentioned limitations for wind turbine systems and to provide control techniques so that the wind turbines can meet the grid requirements in a way that is transparent to system operators, including contributing to frequency regulation and power-swing stabilization for the utility system.

### DESCRIPTION OF THE INVENTION

An exemplary embodiment of the invention includes a wind turbine system comprising of at least one wind turbine generator operable to supply wind turbine power to a utility system, and at least one synchronous generator that is operated in parallel to the wind turbine generator. The wind turbine generator is interfaced to the utility system using a power converter.

A grid measurement device is located between the synchronous generator and the grid in order to measure the current and power exchanged between the synchronous generator and the grid. The output of the grid measurement device is by means of communication transmitted to a controller that is arranged for adjusting the output power of the wind turbine as a function of the power and current that is measured by the grid measurement device. The controller is in one embodiment of the invention an integrated part of an internal wind turbine controller. In another embodiment the controller is an external controller using means of communication between the controller and the wind turbine. The wind turbine is configured to provide current and power to the utility system as a function of the output of the grid measurement device and this way contributing to the stabilization of the grid frequency in case of imbalance.

In a preferred embodiment of the invention the wind power system comprises of a number of wind turbines operated in a wind farm. In a further embodiment the wind power system comprises of a number of synchronous generators in parallel with the wind turbines for grid support.

The present invention combines the advantages of the inherent inertia response of the synchronous generator with the possibility of controlling the output power from the wind turbine. The wind turbine is configured to provide current and power to the utility system as a function of the power and current flow that is exchanged between the synchronous generator and the grid. The flow of power and current that is exchanged between the synchronous generator and the grid is affected during dynamic conditions such as load imbalances. The measurement of the power and current flow is in proportion to the imbalance of the grid, and the measurement is hereby used to adjust the output power of the wind turbine for stabilization in response to the imbalance of the utility grid.

The arrangement combines the inherent inertia response of the synchronous generator with the possibility of increasing or decreasing the output power of the wind turbine for a fast stabilization and restoration of the grid frequency. The inertia response of the synchronous generator is continuously contributing to the stabilization of the grid, and no control action is needed in order to provide inertia response in an initial phase of a grid disturbance.

Furthermore, the inertia response of the synchronous generator prevents that excessive control action for the wind turbine is set in case of a minor frequency disturbance on the utility grid. The initial of the phase frequency disturbance is immediately followed by adjusting the output power of the wind turbine by using the power and current reassessments from the grid measurements device.

The output power of the wind turbine can be changed very fast, and it is hereby possible to support the grid in a controlled and efficient manner and in proportion of imbalance. The combination of the synchronous generator and the output power the turbine also provides a fast response to a deviation of the grid frequency.

A relatively large amount of kinetic energy is stored in the rotor of the wind turbine which can be transformed in to electrical power during a grid disturbance. The inertia constant H for a wind turbine is calculated by the following formula:

H=(½ J ŵ2)/(rated MW)s

A typical constant can be in the range of 5 to 10 seconds. The inertia constant express the kinetic energy that is stored in the rotor system at nominal rotor speed. For a rotor system with H=7 the rotor can store kinetic energy equal to nominal rated power for 7 seconds. This is in range of 1-2 times the energy that is stored in a typical synchronous generator for thermal power plants. This way, the inertia response of the synchronous generator and the controllable use of the kinetic energy in the rotor are combined for a very effective and fast stabilization of the grid frequency. Furthermore, a faster restoration of the grid frequency is also achieved.

Due to the use of the synchronous generator it is possible to provide inertia response even in situations where it is impossible to increase or decrease the output power of the wind turbines. For instance in low wind scenarios where the wind turbine is running at a lower speed limit or in high wind situations where maximum power is provided by the wind turbine.

Frequency variations are often short and the inertia response normally has a short duration from 3 power cycles to 10 sec. The wind turbine might be configured to provide more power than rated for a short while, and the wind turbine can hereby be used to provide power to the grid when rated power is produced before and during a frequency drop.

The synchronous generator is preferably operated in a no load/idling condition where the only flow of power between the synchronous generator and the grid, in steady state condition, is due to the losses in the generator such as friction etc. In another embodiment of the invention active power generation and a prime mover control system is used for power swing stabilization. The invention allows that the size of the Synchronous generator is chosen in order to meet the local requirements for frequency stabilization. The invention hereby provides a solution for designing a wind power system with an effective frequency stabilization, which corresponds to the inertia response of conventional hydro or thermal power plant.

This way, it becomes very attractive for utility company's to replace conventional power plants with a wind power system. The utility company's have until now hesitated to replace conventional power plants due to the lack of inertia response and reduced frequency support. Furthermore, the synchronous generator provides dynamic voltage regulation for the grid, which is important for charging control of long AC submarine cables in offshore wind farms.

The behavior of the wind power system becomes much more transparent for the system operators when compared to systems where the frequency stabilization is relying on control of power converters only. In an embodiment of the invention a micro synchronous generator with a relative high inertia is used to provide a high inertia response for the grid.

The synchronous generator might be installed at or nearby a substation of a wind farm. The synchronous generator can be installed either offshore or onshore when operated in parallel with one or more wind turbines that is installed offshore.

The synchronous generator is in an embodiment of the invention operated substantially in a manner similar to the operation of synchronous generators applied at large hydro or thermal power plants. The operation control strategy of the synchronous may comprise frequency control, power oscillations damping control, voltage control or reactive power control.

In a preferred embodiment of the invention the output of the grid measurement device comprises of a measurement signal that is in proportion to the flow of power and current that is exchanged between the synchronous generator and the utility grid. The measurement signal is used to increase or decrease the output power of the wind turbine system in order to stabilize the overall utility system. The measurement signal is zero when the synchronous generator is in a steady state condition e.g. when the frequency and voltage of the utility system is inside the control limits during steady-state conditions.

Under transient conditions, if the system frequency is decreasing the synchronous generator counteracts by transforming rotational kinetic energy into electrical power, which is then delivered to the utility system. The measurement signal is hereby used to increase the output power of the wind turbines in order to enhance stable operation. Similarly, when the system frequency is increasing the synchronous generator is consuming power and current for speeding up, and the measurement signal is then used to decrease the output power of the turbines in order to enhance stable operation of the utility system.

The measurement signal from the grid measurement device is in a preferred embodiment by means of communication transmitted to a controller that is arranged for adjusting the power reference of the wind turbine converter. The measurement signal from the grid measurement device may be continuous or discrete and may be implemented as a closed or open loop function, subject to certain system limits. The means of communication between the grid measurement device and the controller could be based on wired or wireless infrastructure.

The controller is in an embodiment an integrated part of the wind turbine controller of the wind turbine. However, the controller could also be an external controller that is a part of a supervisory controller for adjusting the output power of one or more wind turbines located in a wind farm, and means of communication is used for communication between the controller and the turbine.

In a further embodiment of the invention the controller uses a control technique that increases or decreases the power output as a function of a number of inputs from the grid measurement device. In one embodiment the input signals comprises of 1) A power reference signal from a pitch and power controller, which is used for optimum operation of the turbine with respect to power and loads 2) the measurement signal from the grid measurement device and 3) An external power reference signal, which is used as a power reference signal for the controller in order to stabilize and restore the frequency of the grid at nominal frequency e.g. 50 or 60 Hz. The controller is thus configured for modulating flow of power through the wind turbine converter in response to frequency disturbances or power oscillations of the utility system.

In another embodiment of the invention the controller is configured to provide a blade pitch control signal or a turbine speed control signal in response to the frequency disturbances or power oscillations of the utility system as a function of the synchronous generator response to the utility system. The input signal for the controller could also comprise of a torque or a power signal that is a function of the synchronous generator response to the utility system.

A limit function is in an exemplary embodiment additionally employed in the controller for physical limitation on the wind turbine system, such as a power limit, a torque limit, a current limit, an energy limit, or a wind turbine generator rotor speed limit etc. Limits are useful in order to ensure that the operation of the turbine is kept within the design limit of the loads on the mechanical and electrical system.

The grid measurement device is in a preferred embodiment of the invention located near the terminals of the synchronous generator in order to measure the current and power flow exchanged between the grid and synchronous generator. A grid filter can be arranged between the grid and the grid measurement device for reducing electrical noise such as harmonics from power converters etc. The grid filter comprises of a number of filter elements that effectively isolates the grid measuring device from measuring any feedback from other elements on the utility system, e.g. from the wind turbine converter. The grid filter allows the fundamental frequency voltage waveform of the utility system to pass from the utility system to the synchronous generator to ensure grid support during grid incidents and to avoid that excessive control action is set due to noise.

In an embodiment of the invention the main shaft of the synchronous generator is coupled to a motor such as a diesel engine, electro motor or the like. A small starter motor can be used for synchronization of the synchronous generator during startup. A prime mover can be used for simulation and test purposes for the wind power system. In a further embodiment of the invention a combination of a prime mover, active power generation and a power system stabilizer control is used for stabilization of power swings.

In another embodiment of the invention the wind power system comprises an energy storage element, an energy consumer element or combinations thereof, wherein the energy storage element, the energy consumer element or the combinations thereof are coupled to a converter.

In another embodiment of the invention the synchronous generator is connected to a controller in order to use the synchronous generator for generation or absorption of reactive power, and hereby providing the possibility for improved grid support.

### FIGURES

The invention will be described in the following with reference to the figures in which

FIG. 1 shows an embodiment of the invention comprising a wind turbine in connection with a synchronous generator.

FIG. 2 shows a diagrammatic illustration of the controller.

FIG. 3 shows a diagrammatical representation of a wind farm comprising a synchronous generator and control means for stabilizing power and frequency on the utility grid.

### DETAILED DESCRIPTION

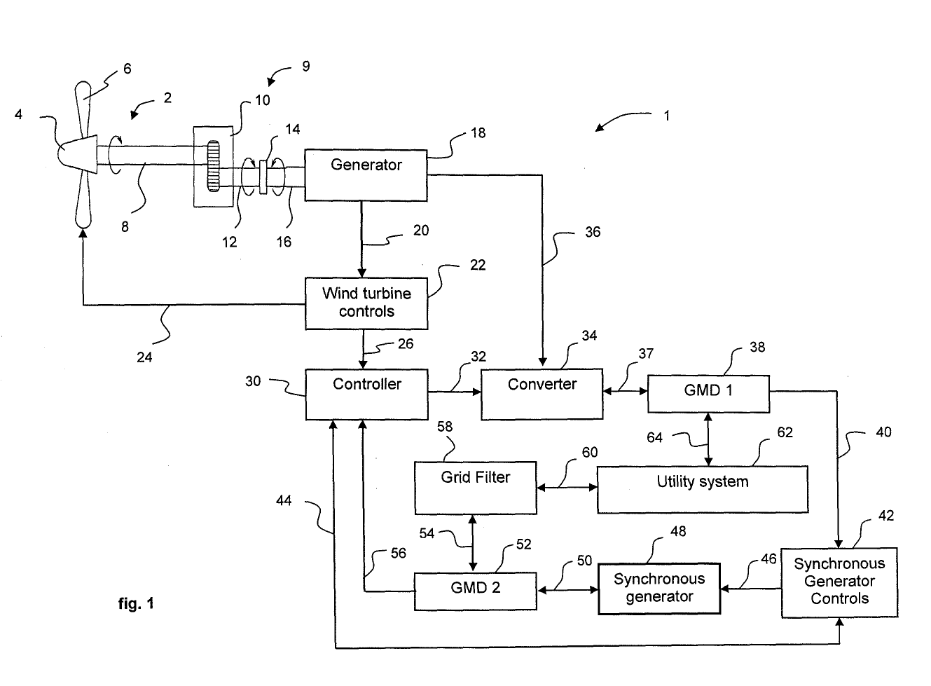

Referring generally to FIG. 1, a wind turbine system 1 operable to generate electric power is provided. The wind turbine system 1 comprises a hub 4 having multiple blades 6. The blades 6 convert the mechanical energy of the wind into a rotational torque, which is further converted into electrical energy by the wind turbine system 1. The wind turbine system 1 further includes a turbine portion 2 that is operable to convert the mechanical energy of the wind into a rotational torque and a generator 18 that is operable to convert the rotational torque produced by the turbine portion 2 into electrical power. A drive train 9 is provided to couple the turbine portion 2 to the generator 18. The wind turbine generator 18 typically comprises a generator for use with a full converter. In a full conversion embodiment, the wind turbine generator stator windings are directly fed to the converter.

The turbine portion 2 includes a turbine rotor low-speed shaft 8 that is coupled to the hub 4. Rotational torque is transmitted from the rotor low-speed shaft 8 to a generator shaft 16 via the drive train 9. In certain embodiments, such as the embodiment illustrated in FIG. 1, the drive train 9 includes a gear box 10 transmitting torque from a low-speed shaft 12 to a high speed shaft 12. The high speed shaft 12 is coupled to the generator shaft 16 with a coupling element 14.

In other embodiments, where the drive train includes no gear box, the low speed shaft is transmitting torque directly to a low speed, direct driven multi pole generator.

As the speed of the turbine rotor low-speed shaft 8 fluctuates, the frequency of the output of the generator 18 also varies. In one implementation of the above embodiment, the transient overload capability of the wind turbine electrical and mechanical systems at full load is utilized by decreasing blade pitch and/or turbine speed to transiently increase power. The degree and duration of this overload are managed such that undue stress on the mechanical and electrical system components is avoided.

In one exemplary embodiment, the generator 18 is coupled to wind turbine controls 22. The wind turbines control 22 receives signals 20 from the generator that are representative of the operating parameters of the generator. The wind turbine controls 22 in response may generate control signals, for example a pitch signal 24 to change the pitch of the blades 6.

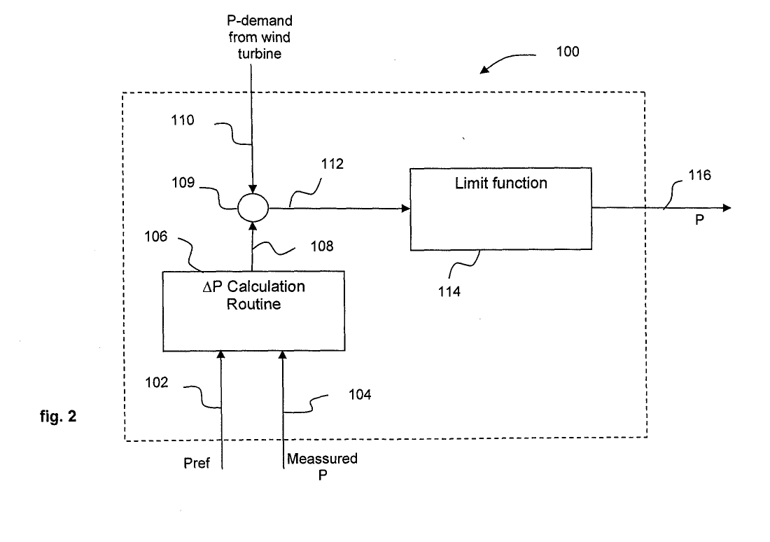

The wind turbine controls 22 are also coupled to a converter 34. The input 48 from the wind turbine controls 44 is supplied as input 48 to the controller 30. The input 26 from the controller 30 is supplied to the converter 34. The converter 34 typically includes power electronics components to convert the variable frequency output 36 of the generator 18 into a fixed frequency output 37 for supply to a utility system or a power grid 62. The wind turbine controls 22, controller 30 and converter 34 are described in more detail with reference to FIG. 2.

The controller 30 is configured for modulating flow of power through the converter 34. The controller 30 receives grid data from a grid measuring device GMD 2 52. The grid measuring device is measuring grid data, such as power and current at the output terminals of a synchronous generator 48. The measurement signal 56 is transmitted to the controller 30 by communication means.

The measurement signal 56 may be representative of the synchronous generator control parameters, for example frequency or power including response to utility system frequency disturbances or power swings. A power reference input signal 44 for the controller 30 is supplied by synchronous generator controls 42. The Synchronous generator controls is in an embodiment of the invention used for ensuring stabilization and restoration of the grid frequency.

A grid measurement device (GMD1) 38 is connected to the synchronous generator in order to measure the output power and response of the wind turbines for control purposes. The synchronous generator control 42 is connected to the synchronous generator 48 for controlling the generator 48. The synchronous generator 48 is operated substantially in a manner similar to the operation of synchronous generators applied at large hydro or thermal power plants.

The synchronous generator 48 is connected to the grid via a grid filter 58. The grid filter 58 may comprise filter elements that effectively isolates the grid measuring device 52 from measuring any feedback from other elements on the utility system 62, e.g. from the converter 34. The grid filter 58 may allow the utility system fundamental frequency voltage waveform to pass from the utility system 62 to the synchronous generator 48 to ensure an inertia response to a frequency disturbance on the utility system.

FIG. 2 is a diagrammatic illustration of an exemplary control loop employed in the controller 100 The controller 100 provides an input signal 116 to the converter (shown in FIG. 1), which input signal may comprise a power or torque signal and is denoted generally by reference numeral 116 and symbol P. It may be noted that power and torque are used interchangeably in the description herein. As discussed in more detail below, the input signal P is typically a function of the signal P demand signal 110 from the wind turbine controls and measurement signal 104 that is measured at grid measuring device (shown in FIG. 1).

The measured signal 104 represents the active power response measured at the output terminals of the synchronous generator. The signal denoted by reference 08 and symbol ΔP is multiplied by a scaling factor that represents the ratio in rated power between the wind turbine generator and the synchronous generator.

The measurement signal 104 is expected to lead to an increase or decrease in power output of the wind turbine system to stabilize the overall utility system. The difference between the signal 104 and the signal 102 is zero when the synchronous generator is in steady-state condition e.g. when the utility system frequency and voltage is inside the control limits during the steady-state condition. Under transient conditions, if the system frequency is decreasing then the signal 108 need to be increased in positive direction to enhance stable operation.

Similarly, if the system frequency is increasing then the signal 108 need to be increased in negative direction to enhance stable operation of the utility system. Further, the supplemental input signal 108 may be continuous or discrete and may be implemented as a closed or open loop function, subject to certain system limits as discussed below.

Referring back to FIG. 2, a torque or power demand signal 110 from wind turbine controls may also be provided as an input to the controller 100. The signal 108 and the command signal 110 may be summed in the summation element 109. The Converter typically includes a local converter controller (shown in FIG. 1) for converting the inputs into converter switching signal commands.

The controller 100, as described above, uses a control technique that transiently increases or decreases power output as a function of the input signal 110 from the wind turbine controls and the input signal 104, representing the power flow from the synchronous generator to the utility system (not shown). The ΔP signal 108 to the summation point 109 represents the power offset that is added to the input signal 110 from the wind turbine controls.

In the ΔP calculation routine 106 the input signal 104 that is measured at the grid measuring device is compared with the power reference, input signal 102, from the synchronous generator controls. ΔP is calculated as the difference between input signal 102 and input signal 104. The calculated difference is multiplied by a scaling factor that represents the ratio between the rated power of the wind turbine generator and the rated power of the synchronous generator. The controller 100 is thus configured for modulating flow of power through the converter in response to frequency disturbances of the utility system.

A limit function 114 is additionally employed in an exemplary embodiment for limiting the power or torque signal 112. Although a single block 114 is illustrated for purposes of example, one or more functions or controllers may be used to implement limit function 114 if desired.

Limits are useful because, when the wind turbine generator is operating at or near rated power output, then an increase in power will tend to overload the generator and converter. The limits used by the limit function 114 may be absolute limits, time-dependent limits, or combinations thereof. Some non-limiting examples of the limits used by the limit function 114 include physical limitations on the wind turbine system, power limits, torque limits, ramp rate limits, energy limits, and rotor speed limits of the wind turbine generator. Examples of physical limits include thermal capability of the power conversion equipment, converter current limits and drive shaft mechanical stress. Examples of energy limits include energy storage and dissipative energy limits.

Further there may be specific upper limits and lower limits for system stability. An upper limit used by the limit function 114 is typically a function of one or more of the following: converter thermal conditions, loading history, time and even ambient temperature. The lower limit will tend to be symmetric compared to the upper limit, although it is not required to be so. Further the limit function can be a limit on the output of a control block, or a limit or deadband on the input to a control block. The deadband limit is type of limit where over some band around zero there is no action and beyond a threshold an action is required to accommodate the limit.

As a specific example, since the total energy balance on the wind turbine dictates the drive-train speed, the energy balance may be used to determine the limits as discussed herein. Power extracted from the turbine, beyond that supplied by wind induced torque, will slow the machine down. The total energy extracted is the integral of this power difference. Also, the turbine has a lower limit on speed, below which stall occurs. Thus, the total energy extracted must also be limited, so that a minimum speed is maintained, with some margin. In one example, a dynamic limit that is a function of the energy extracted may be used to address this aspect.

It will be well appreciated by those skilled in the art that the control technique described herein may be utilized in a system for wind farm management as well.

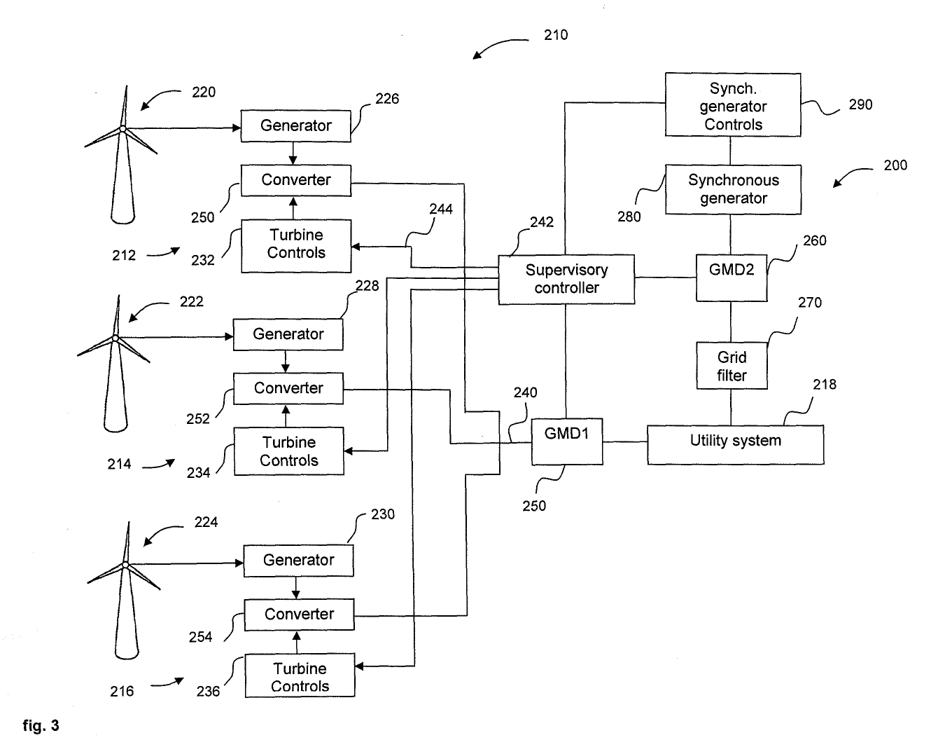

Such a wind farm management system 200 is shown as an exemplary embodiment in FIG. 3. The wind farm management system 200 includes a wind farm 210 having wind turbines 212, 214, and 216 operable to supply electrical power to a utility system 218. It will be appreciated by those skilled in the art that three wind turbines are shown for the purpose of illustration only, and the number may be greater based on the geographical nature and power requirements of any particular region.

Wind turbines 212, 214, 216 include turbine rotors 220, 222, 224, each rotor having multiple blades, which drive rotors 220, 222, 224 respectively to produce mechanical power, which is converted, to electrical power by the generators 226, 228, and 230 respectively. Converters 250, 252, 254 are used to convert the variable frequency output from the generators 226, 228 and 230 respectively into a fixed frequency output. Power produced by generators 226, 228 and 230 may be coupled to a voltage distribution network (not shown), or a collector system (not shown), which is coupled to the utility system. In the illustrated embodiment, a feeder 240 is used to couple power outputs of wind turbine generators 226, 228 and 230. In a typical application, the voltage distribution network couples power from multiple feeders (not shown), each feeder coupling power outputs of multiple wind turbine generators.

In one exemplary embodiment, the wind farm 210 includes a wind farm supervisory controller 242. The supervisory controller 242 is configured to communicate with individual wind turbine controls 232, 234, 236 via communication links 244, which may be implemented in hardware, software, or both. In certain embodiments, the communication links 244 may be configured to remotely communicate data signals to and from the supervisory controller in accordance with any wired or wireless communication protocol known to one skilled in the art. The supervisory controller 242 receives input signals from synchronous generator controls 290 and the grid measuring device GMD2 260. The supervisory controller 242 is coupled to the wind turbine controls 232, 234, 236, and is configured for modulating flow of power through the converters 250, 252, 254 in response to utility system frequency disturbances or power swings. The functionality of the supervisory controller 242 will be similar to that of controller 100 described in reference to FIG. 2. In another embodiment, a plurality of controllers of the type shown in FIG. 1 is provided to modulate the flow of power through each respective converter. In further embodiment the wind turbine controls 232,234,236 is integrated part of a pitch and power control for the wind turbine.

It will be appreciated by those skilled in the art, that the wind turbine system has been referred in the above embodiments as an exemplary power generation and power management system coupled to the utility system. Aspects of present technique are equally applicable to other distributed generation sources operable to supply power to the utility system. Examples of such sources include fuel cells, micro turbines and photovoltaic systems. Such power managements systems will similarly include converters, each converter coupled to a respective generation source and the utility system, and an individual or supervisory controller coupled to the converters. As explained herein above, the controller includes an internal reference frame configured for modulating flow of power through the converters in response to frequency disturbances or power swings of the utility system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wind turbine system comprising:
a wind turbine operable to supply wind power to an utility system;
a synchronous generator coupled to the utility system;
a grid measurement device arranged for measuring the current and power that is exchanged between the synchronous generator and the utility system;
a controller for adjusting the output power of the wind turbine as a function of the power and current that is measured by the grid measurement device; and
a means of communication between the grid measurement device, controller and/or the wind turbine, wherein the wind turbine is configured to provide current and power to the utility system as a function of the measured power and current of the grid measurement device.

2. The wind turbine system according to claim 1, wherein the controller is further configured to provide a blade pitch control signal or a turbine speed control signal in response to the frequency disturbances or the power oscillations of the utility system as a function of the synchronous generator response to the utility system.

3. The wind turbine system according claim 1, wherein an input signal for the controller comprises a torque or power signal and is a function of the synchronous generator response to the utility system.

4. The wind turbine system according to claim 1, further comprising a limit function configured for limiting a relative frequency of power flow modulation, a supplemental power or torque signal, or combinations thereof.

5. The wind turbine system according to claim 1, wherein the limit function comprises limits that are operable as a function of at least one of a physical limitation on the wind turbine system, a power limit, a torque limit, a current limit, an energy limit, or a wind turbine generator rotor speed limit.

6. The wind turbine system according to claim 1, wherein the wind turbine generator is at least one of doubly fed asynchronous generator or a generator for use with a full converter.

7. The wind turbine system according to claim 1, comprising an energy storage element, an energy consumer element or combinations thereof, wherein the energy storage element, the energy consumer element or the combinations thereof are coupled to the converter.

8. The wind turbine system according to claim 1, wherein the main shaft of the synchronous generator is coupled to a motor such as a diesel engine, electro motor or the like.

9. The wind turbine system according to claim 1, wherein the synchronous generator is connected to control means in order for the synchronous generator to generate or absorb reactive power.

10. A method for stabilizing frequency and power swing of an utility system, the method comprising the steps of:
supplying power from a wind power generator of a wind-turbine to the utility system;
a synchronous generator, which is coupled to the utility system, providing inertia response for the utility system;
measuring the current and power that is exchanged between the synchronous generator and the utility system by a grid measurement device; and
while means of communication between the grid measurement device and the wind turbine are used,
wherein a wind turbine system is modulating the flow of power from the wind turbine as a function of the power and current measurements.

11. The method of claim 10 further comprising changing the blade pitch or turbine speed in response to the frequency disturbance or the power swing.

12. The method of claim 10 further comprising modulating flow of power in at least one an energy storage element or an energy consumer element in response to frequency disturbances or power swings of the utility system.
